(19) United States
(12) Patent Application Publication
(10) Pub. No.: US 2007/0254130 A1
(43) Pub. Date: Nov. 1, 2007

(54) Laminates with sound absorbing porperties

(76) Inventor: Glenn E. Cheek, Ringgold, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/415,020

(22) Filed: May 1, 2006

(51) Int. Cl. D05C 17/00; B32B 3/02; B32B 33/00

(52) U.S. Cl. 428/95; 428/87

(57) ABSTRACT

An automotive carpet with desirable acoustic properties is formed from a laminate that includes a first layer that includes a carpet face, a second layer comprising a back coating composition, a third layer that is formed from polyolefin particles and a fourth layer that is a foam layer. The laminate can be used as a floor covering or to make automotive floor mats with desirable sound absorbing properties and may further include an optional nonwoven layer to improve the stiffness of the laminate and floor mats incorporating the laminate.

### BACKGROUND OF THE INVENTION

1. Field of the Invention

The present invention relates to carpet laminates and particularly carpet laminates that are utilized within automobiles and other vehicles.

2. Description of the Related Art

Generally, it is considered desirable to reduce the level of noise within a vehicle passenger compartment. Transmission of external noises, such as road noise, engine noise, vibrations and the like into a passenger compartment as well as transmission of sounds, such as loud music, from within a passenger compartment out can be reduced through the use of acoustical materials. Accordingly, sound absorbing and/or deadening materials for vehicles, in particular luxury automobiles, are used in carpeting, headliners, seats, dashboards, floor mats, trunk liners, undercoatings, wheel wells, and under hoods among other areas.

Carpeting for use within vehicles is conventionally tufted such as pile or cut and loop or nonwoven. Tufted carpet generally includes a composite structure in which tufts, or bundles of carpet fibers are introduced, such as by stitching, into a primary backing, such as a woven or non-woven fabric. Nonwoven fabric is composed of fiber that is mechanically entangled by needling, water jet, or other process. A secondary backing or coating of thermoplastic material is then applied to the underside of the carpet construction in order to securely retain the tufted material in the primary backing. This secondary backing not only dimensionally stabilizes the construction but can also provide greater abrasion and wear resistance, and may serve as an adhesive for an additional layer of material. Carpet laminates may include or are placed over a pad to provide extra cushioning and sound absorption.

In general, the ability of a carpet, more specifically a carpet laminate, to absorb sound increases as the amount of carpet or laminate material increases. Unfortunately, increased carpet material increases the weight as well as the cost of carpet, which is typically undesirable. Accordingly, there is a need for carpet materials for use within vehicles that exhibit good sound absorbing properties and that are also lightweight and low in cost.

### BRIEF SUMMARY OF THE INVENTION

The present invention provides a laminate with sound absorbing properties that includes: a first layer comprising a carpet face, a second layer comprising a back coating composition, a third layer comprising a polyolefin, and a fourth layer comprising a foam. The sound absorbing laminate is useful in automotive interiors, particularly for making floor mats. Desirably, the back coating composition is a latex, a copolymer of styrene and butadiene, a copolymer of ethylene and vinyl acetate or an acrylic polymer and the fourth layer is a foam, preferably a polyurethane foam.

In certain embodiments, the third layer comprises a high density polyethylene and is a porous layer and is formed from particles of high density polyethylene. In certain more desirable embodiments, the third layer comprises at least about 50 weight percent of high density polyethylene, at least about 60 weight percent of high density polyethylene and even at least about 70 weight percent of high density polyethylene. Desirably, the high density polyethylene has a density in the range of from about 0.945 grams per cubic centimeter to about 0.955 grams per cubic centimeter.

In certain embodiments the particles of high density polyethylene that are used to from the third layer have a maximum diameter that is not greater than about 2 millimeters, not greater than about 1.7 millimeters and in some embodiments not greater than about 1.5 millimeters. The first layer may include a primary backing and bundles of fibers or yarns that are twisted at a rate of from about 3 to about 5 turns per inch before the bundles of fibers or yarns are tufted into the primary backing to form the carpet face. The laminate may also include an optional fifth layer between the fourth and the third layers that is a nonwoven fabric. The nonwoven fabric may be formed from spunbonded fibers, spunlaced fibers or a combination thereof. The fifth layer of nonwoven fibers may be adhered to the fourth layer with an adhesive or by flame laminating the fifth layer to the fourth layer.

### BRIEF DESCRIPTION OF THE DRAWINGS

A full and enabling disclosure of the present invention, including the best mode thereof is set forth in the detailed description which makes reference to the appended figures in which:

FIG. 1 is a perspective view of an automotive floor mat,

FIG. 2 is an enlarged, cross-sectional view of a first exemplary carpet laminate of the present invention having a loop pile surface;

FIG. 3 is an enlarged, cross-sectional view of another exemplary carpet laminate of the present invention having a cut pile surface;

FIG. 4 is an enlarged, detailed view of the carpet laminate of FIG. 3;

FIG. 5 is an enlarged, cross-sectional view of a yet another exemplary laminate of the present invention; and

FIG. 6 is an enlarged, detailed view of carpet laminate or FIG. 5.

### DETAILED DESCRIPTION OF THE INVENTION

The drawings and detailed description provide a full and detailed written description of the invention, and of the manner and process of making and using it, so as to enable one skilled in the pertinent art to make and use it, as well as the best mode of carrying out the invention. The detailed description uses numerical and letter designations to refer to features in the drawings. Like or similar designations in the drawings and description have been used to refer to like or similar parts of the invention. The examples set forth in the drawings and detailed description are provided by way of explanation of the invention and are not meant as limitations of the invention. The present invention thus includes any modifications and variations of the following examples as come within the scope of the appended claims and their equivalents.

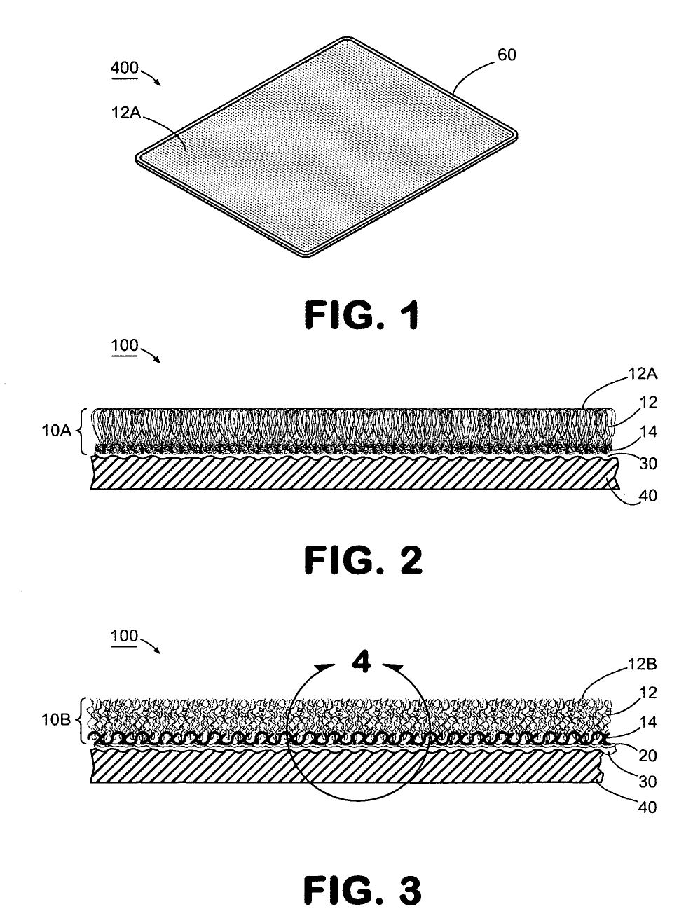

The present invention is primarily concerned with laminates that have acoustical properties that can be used as floor coverings and more particularly floor mats in automobiles. However, the laminates of the present invention may find use in other areas within a vehicle as well as sound absorbing materials for use in other structures, including but not limited to buildings. In a first exemplary embodiment, the present invention provides a laminate with acoustical properties that includes: a first, carpet facing layer; a second, layer formed from a back coating composition, a third porous layer that is formed from polyolefin particles; and a fourth, base layer that is formed from a polyurethane foam. Laminates of the present invention can be used to make automotive floor mats, an example of which is illustrated in perspective in FIG. 1 as floor mat 400 having a looped carpet surface 12A.

Referring now to the drawings, and to those embodiments of the invention here presented by way of illustration, FIG. 2 shows a cross section of an automotive carpet that is a laminate generally designated 100. The exemplary laminate 100 illustrated in FIG. 2 includes a carpet facing layer 10 having a loop pile facing layer 10A that includes face yarns 12 and a primary backing generally designated 14. The first, carpet facing layer 10A forms the uppermost surface of the laminate 100 of the illustrated embodiments and may be any type surface that is used for carpet surfaces. The carpet facing layer 10 may have a pile cut surface 12B as illustrated in FIG.3, a loop surface 12A as illustrated in FIG. 2 or a combination of cut and loop fibers (not illustrated) and can be formed from any type of yarns or fibers that are used to make carpet surfaces including, but not limited to, polyolefin yarns, polyamide (commonly referred to as nylon) yarns and polyester yarns and so forth.

The bundles of fibers or yarns 12 that form the carpet surface 12A or 12B are tufted through a primary backing 14 as is known in the art. In the certain desirable embodiments, the bundles of fibers or yarns 12 are twisted a rate of about 2 turns per inch to about 6 turns per inch, more preferably from about 3 to about 5 turns per inch and in an exemplary embodiment, the fibers are twisted 4 and a half turns per inch before the bundles of fibers or yarns 12 are tufted through primary backing 14 to form a random loop or a cut pile pattern. In certain embodiments, the bundles of fibers or yarns 12 do are not twisted before tufting. Suggested primary backing materials include, but are not limited to, jute woven backings, woven polypropylene backings, nonwoven polyester backings, nonwoven polyamide backings and other woven and nonwoven backings and the like. In certain desirable embodiments, the primary backing is a jute woven backing or a nylon nonwoven backing or a polyester nonwoven backing, for example a polyethylene terephthalate (PET) nonwoven fabric. Commercial examples of suggested nonwoven backings include, but are not limited to, Colback® thermally bonded spunlaid nonwoven fabric that is made from bi-component filament with a polyester core and a polyamide (nylon 6) skin available from Colbond, Inc, of Enka, N.C. and LUTRADUR® nonwoven fabric that is a PET nonwoven fabric that is marketed as a tufted-carpet carrier by Freudenberg Nonwovens of Durham, N.C. Suggested woven jute backings have a basis weight of from about 8 to about 10 ounces per square yard. And, suggested basis weights nonwoven moldable primary backings have basis weights that range from about 100 grams per square meter (about 2.9 ounces per square yard) to about 120 grams per square meter (about 3.5 ounces per square yard).

To minimize the loss of fibers and tufts, a layer 20 of back coating composition can be applied to underside of the primary backing 14. A back coating can be used to lock in the back stitches of the carpet and improve wearability of the carpet laminate. By way of nonlimiting example, the back coating composition may be or include a latex such as natural latex, a copolymer of styrene and butadiene such as a styrene butadiene rubber (SBR), a copolymer of ethylene and vinyl acetate (EVA) or a polymer or an acrylate referred to generally as an acrylic, or any combination or variation thereof. Suggested commercially available, back coating compositions include, but are not limited to, styrene butadiene rubbers and modifications thereof.

A third, porous layer 30 preferably formed from particles of a polyolefin, such as polypropylene and more preferably polyethylene, or a mixture of polyolefins is applied to the back coated surface of the tufted primary backing. For example, a porous layer of polyolefin can be formed by depositing from about 2 to about 20 ounces of polyolefin particles per square yard of carpet on to the backing of the carpet with the use of a powder coater. More preferably from about 6 to about 12 ounces of polyolefin per square yard and even more preferably from about 8 to about 12 ounces per square yard is powder coated to the back coated surface of the tufted carpet. Desirably, the maximum size of the particles of polyolefin is selected by screening. Suggested polyolefin particles include polyethylene and polypropylene particles that have a maximum diameter (or maximum dimension) that is not greater than about 2 millimeters (mm) and more preferably not greater than about 1.7 mm and still more preferably have a maximum diameter that is not greater than about 1.5 mm. Desirably, the particles have an average maximum dimension that is about 1 mm. In the exemplary embodiment, polyolefin pellets were ground and then sifted through an ASTM E-11 size no 12 mesh screen to obtain smaller polyolefin particles for forming a laminate of the present invention. The particles are preferably thermofusible and can be deposited, dispensed or otherwise applied onto a backing as particles and then heated with for example an infrared lamp so that particles will coalesce, sinter or fuse together to form a porous but rigid layer of polyolefin. The thickness of the layer can and will vary across the width and length of the laminate.

It is suggested that the polyolefin particles include high density polyethylene (HDPE) particles or polypropylene particles to increase stiffness. The polypropylene may be or include recycled polypropylene, for example polypropylene particles that are obtained from recycled milk containers. As stated, including polyethylene particles with higher the density, specifically HDPE, increases the stiffness of the overall carpet laminate 100. High density polyethylenes (HDPEs) have a density of greater than or equal to 0.941 grams per cubic centimeter (g/cc) and particularly suggested high density polyethylenes have a density in the range of from about 0.945 to about 0.955 g/cc. The particles that can be used to form layer 30 may include a mixture of polyolefin particles and in one suggested embodiment include a mixture of HDPE and low density polyethylene (LDPE) particles. Low density polyethylenes have a density in the range of from about 0.910 to about 0.940 g/cc and suggested low density polyethylenes have a density in the range of from about 0.910 to about 0.917 g/cc. Generally, HDPEs have less branching and greater tensile strength than LDPEs but may require higher processing temperatures, for example melting temperature.

In an exemplary embodiment, layer 30 is formed from a mixture of about 75 weight percent of HDPE particles and about 25 weight percent of LDPE particles. Desirably, the layer 30 acts as a moisture barrier but is air permeable to absorb sound. In exemplary embodiments, layer 30 is formed by depositing polyethylene particles onto a latex back coating that has been applied to the back side of the carpet and then heating the polyethylene particles to form a porous layer. The porous layer of polyethylene may be continuous or discontinuous and should not be melt extruded. Melt extruded polyethylene layers are not considered porous and do not have desirable sound absorbing properties. The layer formed from the polyolefin particles varies in thickness throughout the laminate and typically may vary from about 2 microns in thickness to about 1 millimeter in thickness. The polyolefin layer may allow the laminate to be hot molded into non-planar, three-dimensional contours and provides stiffness to the laminate. The stiffness of the layer and the laminate can be varied by the relative amounts of HDPE, LDPE and/or polypropylene used in layer 30.

A base layer 40 is contacted to layer 30 after layer is heated, for example with an infrared lamp, to form the bottom surface of the laminate 100. The laminate 100 can then be passed to a chill roll to cool and fix the laminate. Layer 40 is preferably a foam layer that is formed from polyurethane or a polymer of a urethane or a mixture of urethanes and may be a polyester- or a polyether-polyurethane foam. Preferably, the base layer 40 is a layer of an open cell foam and has a thickness that ranges from about ⅛ of an inch to about ¼ of an inch. Suggested densities for the base layer 40 range from about 1 pound per cubic foot to about 2 pounds per cubic foot and more preferably from about 1.2 to about 1.8 pounds per cubic foot. Desirably, the polyurethane foam layer is air permeable relative to rubber, vinyl, thermoplastic olefin (TPO) and other impermeable layers used in conventional automobile floor mats. Desirably, the foam layer will have a high coefficient of friction to prevent an automotive floor mat from sliding. Such floor mats will have decrease weight and not require the use of spikes, protrusions or other features used in conventional automotive floor mats to keep the floor mat from moving during use.

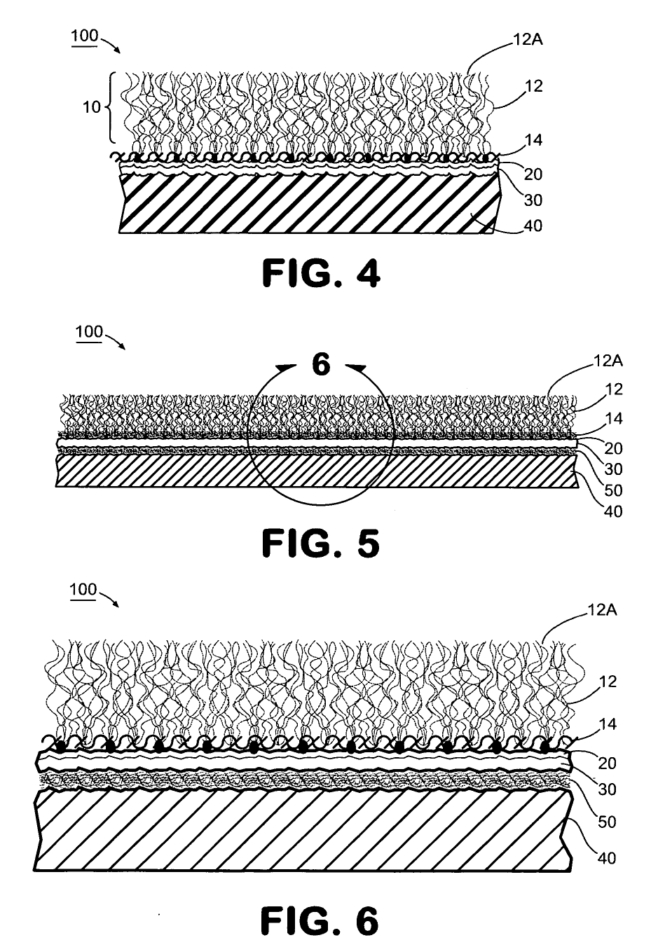

In a second exemplary embodiment, the present invention provides a laminate that further includes an optional, fifth layer 50 of nonwoven fibers. In the embodiment illustrated in FIG. 4 and in greater detail in FIG. 5, optional nonwoven layer 50 is located between the base foam layer 40 and polyolefin layer 30 of the laminate. As used herein, nonwoven layer includes, but is not limited to, a spunbonded layer, a spunlaced layer, or a needle felt layer and laminates thereof and may include nonwoven layers that include spunbonded fibers, spunlaced fibers and combinations of fibers that include spunbonded and/or spunlaced fibers. Suggested nonwoven spunbonded fabrics and nonwoven spunlaced fabrics can be formed from polyesters such a polyethylene terephthalate (PET), polypropylene spunbonded fibers, polypropylene spunlaced fibers, and blends of PET and nylon (polyamides). One suggested nonwoven layer that can be used as an optional layer 50 is a spunbonded, polypropylene nonwoven that was obtained from Freudenberg Nonwovens of Durham, N.C. under the trade name EVOLON®. Suggested nonwoven fabrics for layer 50 can have a basis weight within the range of from about 2 osy to about 20 osy and preferably have a basis weight in the range of from about 10 to about 15 osy.

The illustrated, exemplary laminates 100 were made by a process of manufacture as follows. A textile carpet 10 having a back surface 14 was obtained in roll form. A layer of latex coating was applied to the back surface of the carpet at a rate of about 7 ounces of latex per square yard of carpet. Next, polyethylene particles were deposited over the latex back coating. The polyethylene particles were applied to the coated carpet at a density of about 6 to about 7 ounces per square yard of carpet and then heated with an infrared lamp. Next a layer of polyurethane foam obtained from a roll is contacted to the heated back surface of the carpet coated with polyethylene and pressure was applied to attach the foam backing to the coated back surface of the carpet. The laminate including the foam layer were then passed through a chill roll with pressure to form a sound-absorbing, unitary carpet laminate 100.

In an alternative embodiment, the foam layer 40 is flame laminated to layer 30 or optional nonwoven layer 50 by flame heating lamination. For example, a flame may be used to melt a surface of the foam layer which can then be contacted to the layer 30 or optional layer 50 of the laminate and then cooled to weld layer 40 to layer 30 or layer 50. As previously stated, optional layer 50 may be a spunbonded nonwoven fabric, needle felt nonwoven fabric or a spunlaced nonwoven fabric. The unitary carpet structure may be cut to size for hot molding to a desired shape as is known in the art. In certain embodiments, the sound-absorbing carpet laminate of the present invention is cut and shaped into mats that are designed and adapted to be placed on the carpet surface of automobiles. The mats may include serging or binding tapes 60 at the perimeters of the mats to provide finished edges and/or to protect the edges of the mats.

Laminate materials of the present invention can have beneficial sound absorbing and/or deadening properties as well as reduced weight. The laminate materials of the present invention are believed to absorb and/or deaden sound by allowing sound to be transmitted through the laminate and deadened as opposed to reflecting or otherwise transmitting sound. Thus, laminates of the present invention are desirable for use as interior coverings in automobiles and to make automotive floor mats. The floor mats can be original equipment that is sold with the automobile or can be sold as aftermarket, replacement floor mats and carpets. Although the present invention has been primarily described with respect to laminates can be used as floor coverings and floor mats, laminates of the present invention may find use in other areas within a vehicle as well as sound absorbing materials for use in other structures including, but not limited to, commercial and residential buildings.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

We claim:

1. A laminate comprising:
a first layer comprising a carpet face,
a second layer comprising a back coating composition,
a third layer comprising a polyolefin, and
a fourth layer comprising a foam.

2. The laminate of claim 1 wherein the third layer that comprises a high density polyethylene and is a porous layer and is formed from particles of high density polyethylene.

3. The laminate of claim 1 wherein the third layer that comprises at least about 50 weight percent of high density polyethylene.

4. The laminate of claim 1 wherein the third layer that comprises at least about 60 weight percent of high density polyethylene.

5. The laminate of claim 1 wherein the third layer that comprises at least about 70 weight percent of high density polyethylene.

6. The laminate of claim 2 wherein the high density polyethylene has a density in the range of from about 0.945 grams per cubic centimeter to about 0.955 grams per cubic centimeter.

7. The laminate of claim 2 wherein the particles of high density polyethylene have a maximum diameter that is not greater than about 2 millimeters.

8. The laminate of claim 2 wherein the particles of high density polyethylene have a maximum diameter that is not greater than about 1.7 millimeters.

9. The laminate of claim 2 wherein the particles of high density polyethylene have a maximum diameter that is not greater than about 1.5 millimeters.

10. The laminate of claim 1 wherein the first layer comprises a primary backing and bundles of fibers or yarns that are twisted at a rate of from about 3 to about 5 turns per inch before the bundles of fibers or yarns are tufted into the primary backing to form the carpet face.

11. The laminate of claim 1 further comprising a fifth layer that comprises nonwoven fibers.

12. The laminate of claim 1 further comprising a fifth layer that comprises a nonwoven fabric that is formed from spunbonded fibers, spunlaced fibers or a combination thereof.

13. The laminate of claim 1 further comprising a fifth layer disposed between the first layer and the second layer wherein the fifth layer comprises nonwoven fibers.

14. The laminate of claim 1 further comprising a fifth layer disposed between the first layer and the second layer wherein the fifth layer comprises nonwoven fibers and is adhered to the fourth layer with an adhesive latex or by flame laminating the fifth layer to the fourth layer.

15. The laminate of claim 1 wherein the back coating composition comprises a latex, a copolymer of styrene and butadiene, a copolymer of ethylene and vinyl acetate or an acrylic polymer.

16. The laminate of claim 1 wherein foam is a polyurethane foam.

17. A sound absorbing material comprising the laminate of claim 1.

18. A floor mat comprising the laminate of claim 1.

19. An automotive floor mat comprising the laminate of claim 1

20. A floor mat comprising the laminate of claim 1 wherein the floor mat comprises a periphery and the periphery comprises serging or binding tape.
